(19) United States
(12) Patent Application Publication
(10) Pub. No.: US 2020/0410448 A1
(43) Pub. Date: Dec. 31, 2020

(54) APPROVING REQUESTS USING A DYNAMIC GROUP OF APPROVERS

(71) Applicant: International Business Machines Corporation, Armonk, NY (US)

(72) Inventors: Vaibhav Vijay Gadge, Pune (IN); Nishant Sinha, Pune (IN); Ramakrishna Gorthi, Pune (IN)

(21) Appl. No.: 16/453,178

(22) Filed: Jun. 26, 2019

(51) Int. Cl. G06Q 10/10; G06Q 10/06; G06F 17/27

(52) U.S. Cl. CPC G06Q 10/103; G06F 17/2785; G06F 17/271; G06Q 10/0635

(57) ABSTRACT

A method, a system, and a computer program process for creating and operating a dynamic approval system. These can include analyzing a request from a requester with a natural language processor, determining a minimum number of approval points required to approve the request, communicating with an information system external to the dynamic approval system, and analyzing an approver, including determining a number of approval points allotted to the approver. Further included are adding the approver to an approval group, including adding the number of approval points to a group number of approval points, comparing the group number of potential approval points to the minimum number of approval points, and sending an approval request to the approver in response to the group number of potential approval points having been greater than or equal to the minimum number of approval points.

### BACKGROUND

Many organizations, such as businesses or government entities, have assets to which access is restricted. Whether the restriction is due to factors like importance, sensitivity, or cost, sometimes the assets must be accessed by members of the organization. Therefore, there will be a system and a process that the members can use to gain access to a particular restricted asset. Such systems and processes can require the approval of certain other members in the organization, which can increase the amount of time that the asset is inaccessible to the requesting member.

### SUMMARY

According embodiments of the present disclosure, a method, a system, and a computer program process include analyzing a request from a requester with a natural language processor, determining a minimum number of approval points required to approve the request, communicating with an information system external to the dynamic approval system, and analyzing an approver by determining a number of approval points allotted to the approver. Further included are adding the approver to an approval group, including adding the number of approval points to a group number of approval points, comparing the group number of potential approval points to the minimum number of approval points, and sending an approval request to the approver in response to the group number of potential approval points having been greater than or equal to the minimum number of approval points.

### BRIEF DESCRIPTION OF THE DRAWINGS

FIG. 1 depicts a schematic view of an organization having a dynamic approval system according to embodiments of the present disclosure.

FIG. 2 depicts a schematic view of a dynamic approval system according to embodiments of the present disclosure.

FIG. 3 depicts a flowchart of a process of approving a transaction in the dynamic approval system according to embodiments of the present disclosure.

FIG. 4 depicts a high-level block diagram of an example computer system that may be used in implementing embodiments of the present disclosure.

FIG. 5 depicts a block diagram of an example natural language processing system configured to provide relevant information to a suppressing tool regarding maintenance events, according to an embodiment of the present disclosure.

FIG. 6 depicts a cloud computing environment according to an embodiment of the present disclosure.

FIG. 7 depicts abstraction model layers according to an embodiment of the present disclosure.

### DETAILED DESCRIPTION

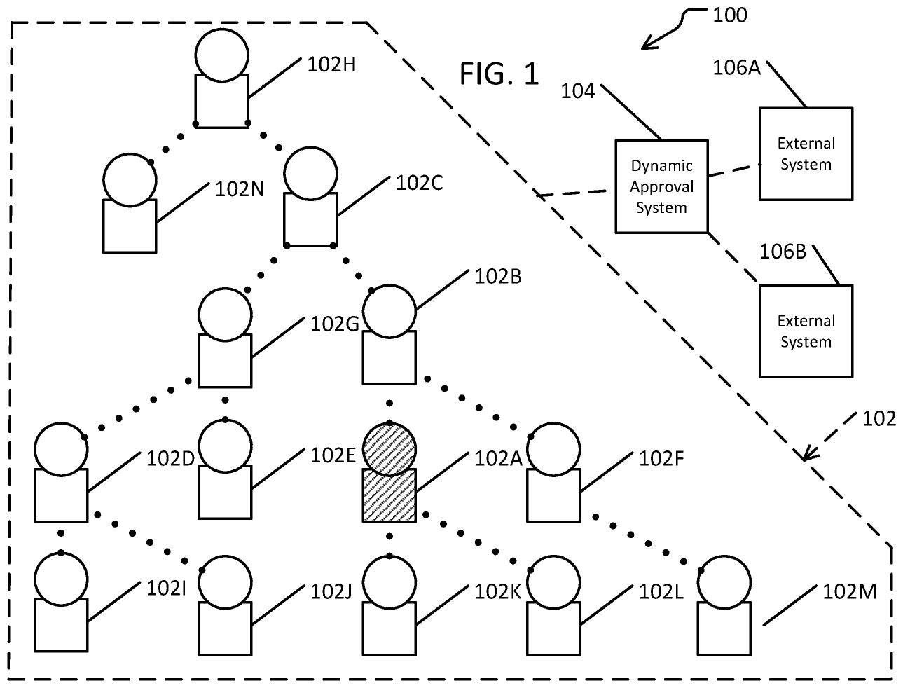

FIG. 1 shows a schematic view of organization 100 having members 102 and dynamic approval system 104 according to embodiments of the present disclosure. In the illustrated embodiment, members 102A-102N (collectively “members 102”) have been organized into a hierarchy, which is common among many organizations, such as businesses and government entities.

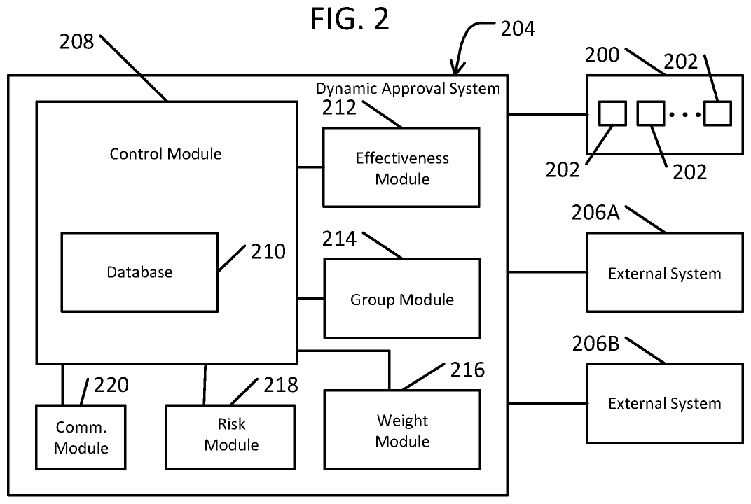

According to some embodiments, each member 102 can access dynamic approval system 104, for example, though one or more connected computing devices (see terminals 202 in FIG. 2) such as smartphone(s), tablet(s), laptop computer(s), desktop computer(s), or workstation(s). Dynamic approval system 104 is further connected to external systems 106A and 106B. External systems 106 can be, for example, a computing system, database, intranet, container, and/or cloud that belongs to organization 100. In addition to or in the alternative, external systems 106 can be a computing system, database, container, and/or cloud that belongs to a third-party and/or a network such as the Internet.

During use of dynamic approval system 104, any member 102 can initiate a request to do or receive something that requires approval. Requests can be for things such as use of hardware or software resources, permission to modify documents or computer code, access sensitive or restricted information, expenditure of monetary funds or use of credit and the like. Then one or more other members of organization 100 will be asked to approve or deny the request.

The dynamic nature of dynamic approval system 104 is related to the ability to change which member(s) 102 need to approve a request depending on the situation. Dynamic approval system 104 will assign each request with a threshold number of approval points that needs to be garnered for approval. In turn, each member 102 that is asked to approve the request is allotted a number of approval points that they can give to that request. Therefore, the group of one or more members 102 being asked to approve the request will collectively have at least as many approval points amongst themselves as is required to approve the request. Since which members 102 are being asked to approve a given request can be changed, and it does not matter who the points come from (as long as there are enough of them in total). Under certain circumstances, dynamic approval system 104 can replace some or all of the members 102 currently being asked to approve a request (for example, if they are unresponsive) with new members 102, which can prevent approval of a request from being delayed unnecessarily. Similarly, new members 102 can be added to the group of approvers without any current members 102 being removed.

In one example, member 102A (denoted by hashing in FIG. 1) would like permission to read the software source code for a peripheral software module made by organization 100. There is some risk in allowing member 102A to see the code because it is a trade secret, although since member 102A will not be able to change the code, the risk is not very high. Therefore, the number of approval points required will be relatively low, which can be provided solely by the approval of member 102A's manager.

In this example, member 102A accesses dynamic approval system 104 and requests read-only permission for the code. This request is sent by dynamic approval system 104 to member 102B since member 102B is the direct superior of member 102A. However, member 102B does not respond to the request, so after a period of time, the request is transferred to member 102C since member 102C is two levels above member 102A. However, member 102C has too many open request approvals already assigned, so the request is transferred to member 102D since member 102D is a peer of member 102A. Unfortunately, member 102D alone does not have enough authority to authorize the request on their own, so members 102E and 102F are also asked to approve or deny the request, thus creating a group of approvers. However, it is determined that member 102E is unavailable for a significant amount of time, so member 102G is considered for addition to the group of approvers since member 102G ranks higher than member 102A (even if member 102A does not report to member 102G). But member 102G does not have the requisite subject matter expertise to be allowed to weigh in on such a decision. Therefore, member 102H is added to the group of approvers (that already includes members 102D and 102F) since member 102H is three levels above member 102A.

This example continues by the deadline for the expiration of the request rapidly approaching, so the group of approvers is opened up the members 102I-102M since members 102I-102M are subordinate and/or report to member 102A. In this manner, the number of approval points needed for a request made by a member 102 can be dynamically changed in real-time depending on, for example, the risk of the request, the structure of the hierarchy, where the requester fits in the hierarchy, the inaction of an approver, the amount of authority an approver has, availability of the potential approvers, the knowledge of a potential approver, and the urgency with which the request must be answered. Thereby, organization 100 can utilize dynamic approval system 104 to process requests in an efficient and rapid manner.

Depicted in FIG. 1 is one embodiment of organization 100 and dynamic approval system 104, to which there are alternative embodiments. For example, organization 100 can have greater or fewer members 102 and/or the hierarchy of members 102 can be structured differently. For another example, dynamic approval system 104 can be connected to greater or fewer external systems 106.

FIG. 2 shows a schematic view of dynamic approval system 204 according to embodiments of the present disclosure. Organization 200 can be similar or the same as organization 100 (shown in FIG. 1), dynamic approval system 204 can be similar to or the same as dynamic approval system 104 (shown in FIG. 1), and external systems 206 can be similar to or the same as external systems 106 (shown in FIG. 1). Furthermore, organization 200 can include terminals 202 for members 102 (shown in FIG. 1) to access dynamic approval system 204, for example, to provide or deny approvals, submit requests, and check request status (e.g., the number of approval points a request has garnered). For the description of FIG. 2, the hierarchy of members 102 of organization 100 will be assumed for organization 200, and reference will be made thereto in the description of FIG. 2.

In the illustrated embodiment, dynamic approval system 204 is connected to organization 200 and external systems 206A and 206B. Dynamic approval system 204 comprises control module 208, database 210, effectiveness module 212, group module 214, weight module 216, risk module 218, and communication module 220. Control module 208 manages dynamic approval system 204 and communicates with the other modules 212-220. Control module 208 also manages requests and includes database 210 for tracking requests, approval points, and approvers. To these ends, database 210 can store data related to, for example, how many points are required for a given request to be approved, how many points have been provided to a given request, when a given request was entered, what the deadline or expiration is for a given request, when the group of approvers should be changed, how many requests a given member 102 has answered, and how many outstanding requests a given member 102 has.

In the illustrated embodiment, effectiveness module 212 determines an effectiveness value for potential approvers (i.e., members 102 who are under consideration for being asked to approve a request). Effectiveness can be a calculated score based on predetermined factors that can be, for example, added or multiplied together, such as load, availability, knowledge, absolute position, and relative position. For example, the load factor can be based on how many outstanding requests a potential approver has. The load score, for example, can be the inverse of the number of outstanding requests a potential approver has, such that a potential approver with one outstanding request would have a load score of one, whereas a potential approver with four outstanding requests would have a load score of 0.25. As stated previously, the number of outstanding requests a potential approver has can be stored in database 210.

Furthermore, if a potential approver is in the office, then their availability score can be, for example, one, and conversely, if potential approver is out of the office, then their availability score can be, for example, zero. If a potential approver has intimate knowledge of the subject matter of the request, then their knowledge score can be a one, and conversely, if potential approver has no knowledge of the subject matter of the request, then their knowledge score can be, for example, zero. The knowledge score can be presented as a spectrum or in increments, such that a potential approver can have a score between one and zero, depending on their knowledge of the subject matter of the request. The knowledge of a potential approver can be demonstrated, for example, by their academic records, resume, hardware or software access, and past approved requests. In addition, a factor in the knowledge score can be how long the potential approver has been a part of organization 200.

The absolute position score can be based on where in the hierarchy of organization 100 a potential approver is. The higher a potential approver is, the higher their score will be. For example, an executive (such as member 102H) can have a score of one, whereas an entry-level employee (such as member 102I) can have a score of 0.2, since there are five levels in the hierarchy. On the other hand, the relative position score can be where the potential approver is positioned relative to the requester. The higher the potential approver is above the requester, the higher the score, and the lower the potential approver is below the requester, the lower the score.

In the illustrated embodiment, information used to determine the availability, knowledge, absolute position, and relative position scores can come from external systems 206. For example, an email server can provide information on whether a potential approver has an automatic out-of-office reply set up, indicating that the potential approver is unavailable. For another example, an instant messaging server can provide information on whether a potential approver is logged in, indicating that the potential approver is available. For another example, a human resources system can provide information about a potential approver's subject matter expertise, length of employment, and position in the organizational hierarchy (as well as the position of the requester).

In the illustrated embodiment, group module 214 determines the composition of the group of approvers for a given request, which can be changed dynamically. Group module 214 uses information from the request to determine what the request is for (for example, the exact asset involved, the general subject matter that the asset belongs to, and who the requestor is). Group module 214 also uses the effectiveness score from effectiveness module 212 and compares it to a threshold value. If the effectiveness score is at or above the threshold, then the given potential approver can join the approval group. If the effectiveness score is below the threshold, then the given potential approver is passed over and the next potential approver is analyzed.

Therefore, group module 214 also includes a procedure and/or rules for moving through the hierarchy to find potential approvers. An example of such a procedure is demonstrated by the reference numerals of FIG. 2. In this example, the first potential approver to be analyzed is found by going up one level (member 102B) from the requestor (in this case, member 102A), then go up two levels (member 102C), then go over to peers (members 102D-102F), then go up one level and over (member 102G), then go up three levels (member 102H), then go down one level (102I-102M), then go up two levels and over (member 102N).

Group module 214 also adds approvers to the approval group until the group has enough points in total to meet or exceed the number of points required to approve a given request. Sometimes group module 214 will create groups that only can supply the minimum number of points for approval (thus requiring a consensus of the group). Other times group module 214 will create groups with many more available points, for example, 1.5, 2.0, or 3.0 times as many as the required number of points. However, any number of available points can be used.

These calculations are performed with the assistance of weight module 216. In the illustrated embodiment, weight module 216 allocates points to each approver in the approval group, for example, based on their respective positions in the organizational hierarchy. The exact number of points that a given approver is allotted can be based on their absolute position and/or their relative position with respect to the requester. For example, the approval of member 102H can count for five points whereas the approval of member 102I can count for one point since member 102H is five levels above member 102I. Alternatively, the approvals of members 102B, 102C, and 102H can count for two points each since they are above member 102A, whereas the approvals of members 102D and 102I can count for one point each since they are at or below member 102A.

In the illustrated embodiment, risk module 218 determines the risk level associated with a given request. This information can be used by control module 208 to determine the number of approval points that a given request will need. In general, the higher the risk, then higher the required number of approval points, and the lower the risk, then lower the required number of approval points. For example, if a new member 102 requests access to edit source code of a product, risk module 218 can assign a high level of risk to that request. For another example, if a longstanding member 102 requests access to use commercially-available spreadsheet software, risk module 218 can assign a low level of risk to that request.

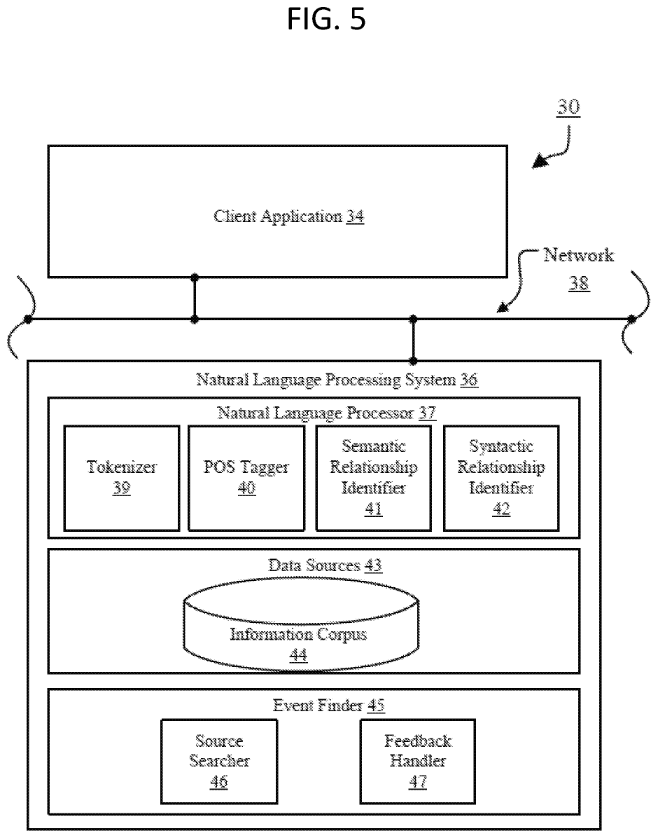

In the illustrated embodiment, communication module 220 is responsible for communications between dynamic approval system 204 and organization 200 (via terminals 202) and external systems 206. To this end, communication module 220 includes a natural language processing system (see FIG. 5) that can parse and datamine incoming messages and formulate outgoing messages. Thereby, dynamic approval system 204 can understand what is being requested and can send out messages, such as approval requests and status updates.

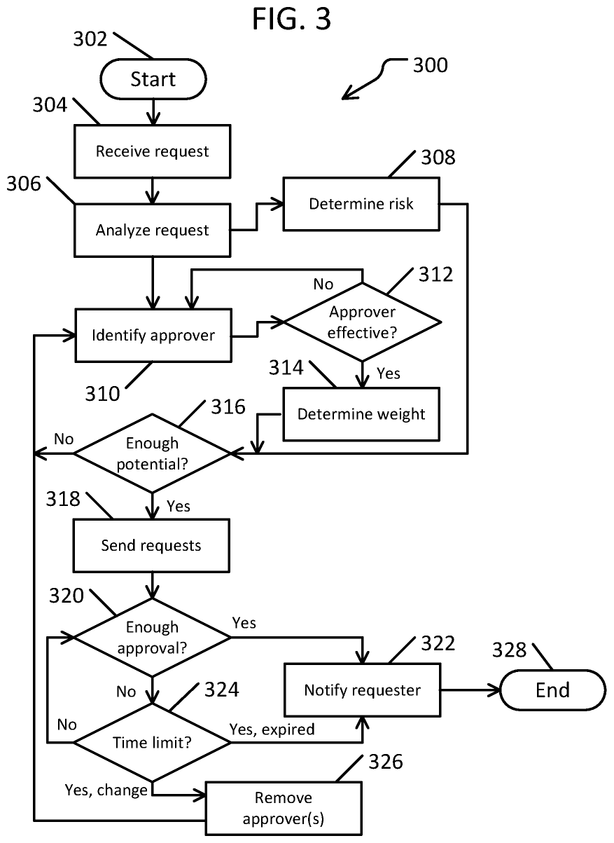

FIG. 3 shows a flowchart of process 300 of approving a transaction in a dynamic approval system such as dynamic approval system 104 and/or dynamic approval system 204. Therefore, FIG. 3 will be discussed with respect to some of the features of FIGS. 1 and 2.

In the illustrated embodiment, process 300 begins at step 302. At step 304, the dynamic approval system receives a request from requesting member 102A. At step 306, the request is analyzed to determine important information about the request, such as who the requester is, what the subject matter of the request is, and when the requester needs approval by. At step 308, risk module 218 determines the risk level of the request and assigns an approval points threshold. At step 310, group module 214 identifies the first potential approver (or the next new approver, in subsequent iterations) based on the analysis of the request and the procedure or rules of group module 214. At step 312, effectiveness module 212 analyzes the effectiveness of the potential approver to determine if the potential approver can join the approval group. If not, then process 300 returns to step 310. But if so, at step 314, weight module 216 determines the number of approval points allotted to the potential approver and group module 214 adds the potential approver to the approval group.

In the illustrated embodiment, at step 316, group module 214 determines if the approval group has enough potential points to approve the request. If not, then process 300 returns to step 310 to add more approvers to the approval group. If so, at step 318, approval requests are sent to the approvers by communication module 220. At step 320, control module 208 checks for any approvals submitted to communication module 220 and adds the corresponding number of approval points associated with each approval together to determine if there are enough points to meet or exceed the approval threshold. If so, the request is approved, and the requester is notified as much at step 322. In addition, if there are any outstanding requests for approval, then they are withdrawn by communication module 220. In some embodiments, communication module 220 notifies one or more external systems 106 and/or 206 to take an action related to the approved request. For some examples, an external system 106 or 206 may be directed to allow access to an asset for requesting member 102A, send a copy of an asset to requesting member 102A, and/or transfer funds on behalf of requesting member 102A.

At step 324, control module 208 determines if a time limit has been reached. If not, process 300 returns to step 320 to await approvals from the approvers. But there can be multiple time limits that can apply to a given request, and they can be set in the request or by a predetermined or standard scheme known by control module 208. One example of a time limit is the expiration of time for a given approver to submit their points or the expiration of the request as a whole. If the request itself has expired, then the requester is notified as much at step 322, and any outstanding requests for approval are withdrawn. Then process 300 would end at step 328. On the other hand, if an approver's request has expired, then that approver is removed from the approval group at step 326. Then process 300 returns to step 310 to identify new potential approvers that have not already been added to the group of approvers.

In some situations, an approver may want to be removed from the group of approvers. This can be accomplished by that approver not answering the request and being removed by steps 324 and 326, or that approver can notify dynamic approval system 200 (for example, by replying to the approval request message) as much. In either case, control module 208 will order the execution of steps 310-318 to replace that approver. In other situations, an approver may want to deny a request. Because dynamic approval system 200 can replace an approver that does not answer the approval request, the denial can be made explicitly, for example, by replying to the approval request message. In the situation where group module 214 has only added the minimum number of points required to approve the request, a denial by one approver is essentially a veto of the request. In the situation where group module 214 has added significantly more points than what is required to approve the request, the request can still be approved provided that there are not too many additional denials.

The components and configuration of dynamic approval systems 100 and/or 200 and/or process 300 allow for the automatic creation of an approval group as well as the automatic and dynamic addition and subtraction of members 102 from an approval group for a given request. In addition, the approval requests can be delivered automatically, and the status of a given request can be ascertained automatically upon request.

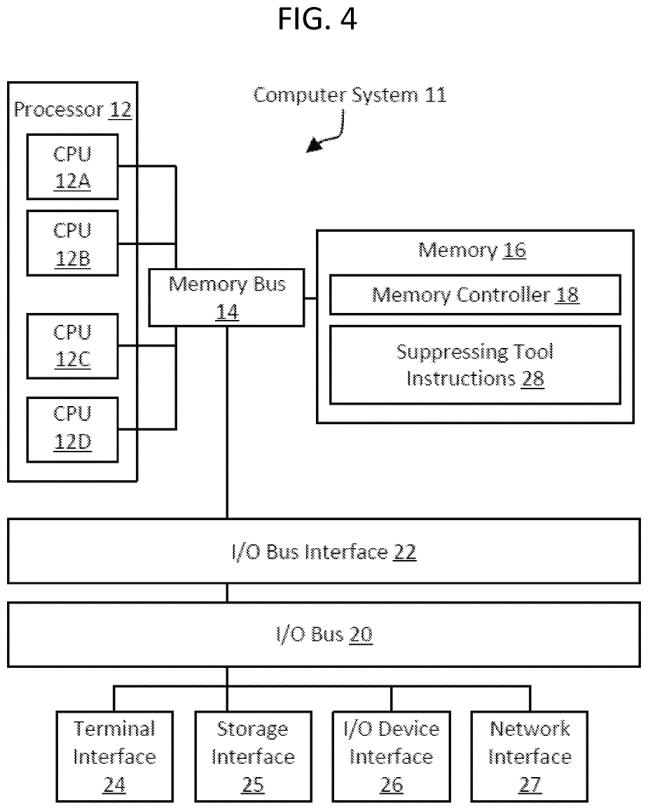

Referring now to FIG. 4, shown is a high-level block diagram of an example computer system (i.e., computer) 11 that may be used in implementing one or more of the methods or modules, and any related functions or operations, described herein (e.g., using one or more processor circuits or computer processors of the computer), in accordance with embodiments of the present disclosure. In some embodiments, the components of the computer system 11 may comprise one or more CPUs 12, a memory subsystem 16, a terminal interface 24, a storage interface 25, an I/O (Input/Output) device interface 26, and a network interface 27, all of which may be communicatively coupled, directly or indirectly, for inter-component communication via a memory bus 14, an I/O bus 20, and an I/O bus interface unit 22.

The computer system 11 may contain one or more general-purpose programmable central processing units (CPUs) 12A, 12B, 12C, and 12D, herein generically referred to as the processer 12. In some embodiments, the computer system 11 may contain multiple processors typical of a relatively large system; however, in other embodiments the computer system 11 may alternatively be a single CPU system. Each CPU 12 may execute instructions stored in the memory subsystem 16 and may comprise one or more levels of on-board cache.

In some embodiments, the memory subsystem 16 may comprise a random-access semiconductor memory, storage device, or storage medium (either volatile or non-volatile) for storing data and programs. In some embodiments, the memory subsystem 16 may represent the entire virtual memory of the computer system 11 and may also include the virtual memory of other computer systems coupled to the computer system 11 or connected via a network. The memory subsystem 16 may be conceptually a single monolithic entity, but, in some embodiments, the memory subsystem 16 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 16 may contain elements for control and flow of memory used by the Processor 12. This may include a memory controller 18.

Although the memory bus 14 is shown in FIG. 4 as a single bus structure providing a direct communication path among the CPUs 12, the memory subsystem 16, and the I/O bus interface 22, the memory bus 14 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 22 and the I/O bus 20 are shown as single respective units, the computer system 11 may, in some embodiments, contain multiple I/O bus interface units 22, multiple I/O buses 20, or both. Further, while multiple I/O interface units are shown, which separate the I/O bus 20 from various communications paths running to the various I/O devices, in other embodiments some or all of the I/O devices may be connected directly to one or more system I/O buses.

In some embodiments, the computer system 11 may be a multi-user mainframe computer system, a single-user system, or a server computer or similar device that has little or no direct user interface but receives requests from other computer systems (clients). Further, in some embodiments, the computer system 11 may be implemented as a desktop computer, portable computer, laptop or notebook computer, tablet computer, pocket computer, telephone, smart phone, mobile device, or any other appropriate type of electronic device.

In the illustrated embodiment, memory subsystem 16 further includes dynamic approval system instructions 28. The execution of dynamic approval system instructions 28 enables computer system 11 to perform one or more of the functions described above for processing a request (for example, method 300, shown in FIG. 3).

It is noted that FIG. 4 is intended to depict representative components of an exemplary computer system 11. In some embodiments, however, individual components may have greater or lesser complexity than as represented in FIG. 4, components other than or in addition to those shown in FIG. 4 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 5 shows a block diagram of an example natural language processing system configured to provide relevant information to an approval management system (such as dynamic approval system 100 and/or 200, shown in FIGS. 1 and 2, respectively) regarding requests that require approval, according to an embodiment of the present disclosure. Aspects of FIG. 5 are directed toward an exemplary system architecture 30, including a natural language processing system 36, to analyze requests and formulate responses to inquiries. In some embodiments, users (such as members 102, shown in FIG. 1) may submit electronic request text and/or documents to the natural language processing system 36 which may be housed in an approval management system (such as dynamic approval system 100 and/or 200). Such an approval management system may include a client application 34 which may itself involve one or more entities operable to generate or modify information in text and/or documents which are then dispatched to natural language processing system 36 via network 38.

Consistent with various embodiments, natural language processing system 36 may find evidence regarding current or future maintenance events and the details thereof. In some embodiments, natural language processing system 36 may include natural language processor 37, data sources 43, and event finder 45. Natural language processor 37 may be a computer module that analyzes the received source documents and other electronic documents. Natural language processor 37 may perform various methods and techniques for analyzing electronic documents (syntactic analysis, semantic analysis, etc.). The natural language processor 37 may be configured to recognize and analyze any number of natural languages. In some embodiments, natural language processor 37 may parse passages of the documents. Further, natural language processor 37 may include various modules to perform analyses of electronic documents. These modules may encompass, but are not limited to, a tokenizer 39, part-of-speech (POS) tagger 40, semantic relationship identifier 41, and syntactic relationship identifier 42.

In some embodiments, tokenizer 39 may be a computer module that performs lexical analysis. Tokenizer 39 may convert a sequence of characters into a sequence of tokens. A token may be a string of characters included in an electronic document and categorized as a meaningful symbol. Further, in some embodiments, tokenizer 39 may identify word boundaries in an electronic document and break any text passages within the document into their component text elements, such as words, multiword tokens, numbers, and punctuation marks. In some embodiments, tokenizer 39 may receive a string of characters, identify the lexemes in the string, and categorize them into tokens.

Consistent with various embodiments, POS tagger 40 may be a computer module that marks up a word in passages to correspond to a particular part of speech. POS tagger 40 may read a passage or other text in natural language and assign a part of speech to each word or other token. POS tagger 40 may determine the part of speech to which a word (or other text element) corresponds based on the definition of the word and the context of the word. The context of a word may be based on its relationship with adjacent and related words in a phrase, sentence, question, or paragraph. In some embodiments, the context of a word may be dependent on one or more previously analyzed electronic documents (e.g., the content of one source document may shed light on the meaning of text elements in another source document). Examples of parts of speech that may be assigned to words include, but are not limited to, nouns, verbs, adjectives, adverbs, and the like. Examples of other part of speech categories that POS tagger 40 may assign include, but are not limited to, comparative or superlative adverbs, wh-adverbs (e.g., when, where, why, whence, whereby, wherein, whereupon), conjunctions, determiners, negative particles, possessive markers, prepositions, wh-pronouns (e.g., who, whom, what, which, whose), and the like. In some embodiments, POS tagger 40 may tag or otherwise annotate tokens of a passage with part of speech categories. In some embodiments, POS tagger 40 may tag tokens or words of a passage to be parsed by natural language processing system 36.

In some embodiments, semantic relationship identifier 41 may be a computer module that may identify semantic relationships of recognized text elements (e.g., words, phrases) in documents. For example, semantic relationship identifier 41 may be able to recognize evidence of events and event details such as what configuration item is involved what type of maintenance will be performed; which configuration items are affected; and what date, time, and duration the maintenance will be. In some embodiments, semantic relationship identifier 41 can recognize terminology relating to a configuration item or subcomponent thereof, such as names of specific machines or programs, change IDs, customer calls, and html queries. In some embodiments, semantic relationship identifier 41 may determine functional dependencies between entities and other semantic relationships.

Consistent with various embodiments, syntactic relationship identifier 42 may be a computer module that may identify syntactic relationships in a passage composed of tokens. Syntactic relationship identifier 42 may determine the grammatical structure of sentences, for example, which groups of words are associated as phrases and which word is the subject or object of a verb. Syntactic relationship identifier 42 may conform to formal grammar.

In some embodiments, natural language processor 37 may be a computer module that may parse a document and generate corresponding data structures for one or more portions of the document. For example, in response to receiving a source document at natural language processing system 36, natural language processor 37 may output parsed text elements from the document as data structures. In some embodiments, a parsed text element may be represented in the form of a parse tree or other graph structure. To generate the parsed text element, natural language processor 37 may trigger computer modules 39-42. Event finder 45 can use functionality provided by computer modules 39-42 individually or in combination. Additionally, in certain embodiments, event finder 45 may use external computer systems for dedicated tasks that are part of the evidence finding process.

In some embodiments, the output of natural language processor 37 may be used by event finder 45 to perform a search of a set of (i.e., one or more) corpora to retrieve evidence of maintenance events. As used herein, a corpus may refer to one or more data sources. In some embodiments, data sources 43 may include data warehouses, information corpora, data models, and document repositories. In some embodiments, the data source 43 may include an information corpus 44. The information corpus 44 may enable data storage and retrieval. In some embodiments, the information corpus 44 may be a storage mechanism that houses a standardized, consistent, clean and integrated form of potential target documents. The data may be sourced from various operational systems. Data stored in the information corpus 44 may be structured in a way to specifically address reporting and analytic requirements. In some embodiments, the information corpus may be a relational database.

In some embodiments, event finder 45 may be a computer module that searches through documents to find evidence of maintenance events. In some embodiments, event finder 45 may include source searcher 46 and feedback handler 47. In some embodiments, feedback handler 47 can be a computer module that processes feedback from users (for example user 128, shown in FIG. 1) on the evidence for maintenance events generated by event finder 45. In some embodiments, users may be engaged in dialog with natural language processing system 36 to evaluate the relevance and meaning of the evidence. In certain embodiments, the feedback of users on these lists may be used for future natural language processing sessions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

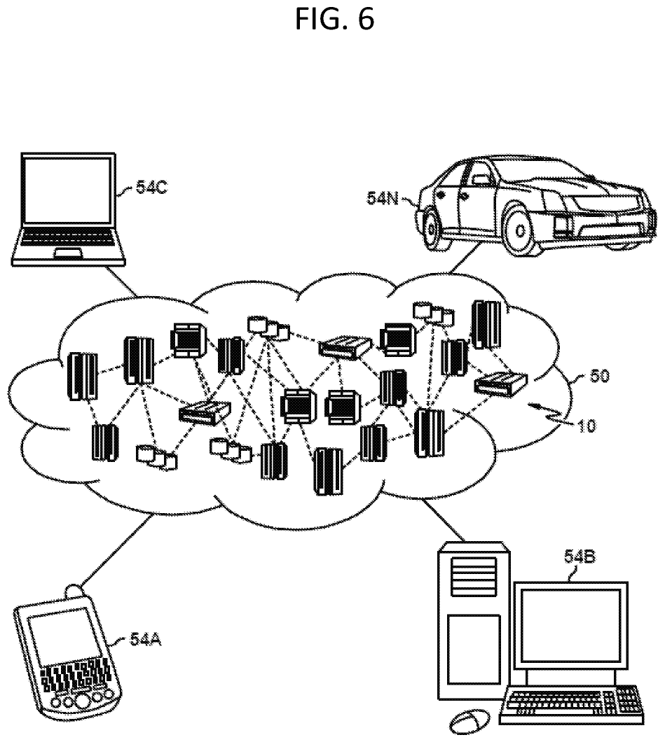

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

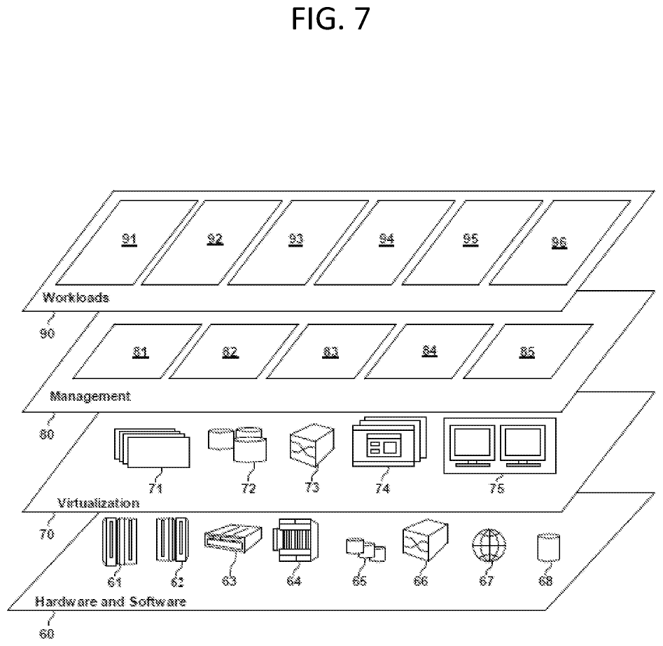

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and approval management 96 via dynamic approval system 100 and/or 200 (shown in FIGS. 1 and 2, respectively).

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of operating a dynamic approval system, the method comprising:
analyzing a request from a requester with a natural language processor;
determining, based on analyzing a risk level of the request, a minimum number of approval points required to approve the request;
communicating, based on analyzing the request, with an information system external to the dynamic approval system;
analyzing a first approver, based on communicating with the information system, including determining a first number of approval points allotted to the first approver;
adding the first approver to an approval group, including adding the first number of approval points to a group number of approval points;
comparing the group number of potential approval points to the minimum number of approval points; and
sending a first approval request to the first approver in response to the group number of potential approval points having been greater than or equal to the minimum number of approval points.

2. The method of claim 1, further comprising:
determining that a first time limit has been reached;
removing the first approver from the approval group;
analyzing a second approver;
adding the second approver to the approval group; and
sending the second approver a second approval request.

3. The method of claim 2, further comprising;
determining that a second time limit has been reached; and
denying the request.

4. The method of claim 1, further comprising:
analyzing a third approver, including determining a third number of approval points allotted to the first approver, in response to the group number of potential approval points being less than the minimum number of approval points;
adding the third approver to an approval group, including adding the third number of approval points to the group number of potential approval points;
comparing again the group number of approval points to the minimum number of approval points; and
sending the first approval request to the first approver and a third approval request to the third approver in response to the group number of potential approval points being greater than or equal to the minimum number of approval points.

5. The method of claim 1, further comprising:
receiving a first approval from the first approver;
adding the first number of approval points to a group number of received approval points;
comparing the group number of received approval points to the minimum number of approval points; and
notifying the requester of approval of the request in response to the group number of received approval points being greater than or equal to the minimum number of approval points.

6. The method of claim 1, wherein analyzing the first approver further comprises:
determining, based on communicating with the external information system, a first effectiveness of the first approver with respect to the request.

7. The method of claim 6, wherein the first effectiveness is based on a request load, an availability, request subject matter knowledge, an absolute position in an organization of the first approver, and a relative position in the organization with respect to the requester.

8. A dynamic approval system comprising:
a control module for managing the dynamic approval system;
an effectiveness module for determining an effectiveness value of a potential approver;
a group module for identifying the potential approver based on an analysis of a request;
a weight module for allocating approval points to each approver in an approval group;
a risk module for determining a risk level associated with the request;
a communication module;
a computing processor; and
a memory coupled to the computing processor, wherein the memory comprises instructions which, when executed by the computing processor, specifically configures the computing processor and causes the computing processor to:
analyze the request from a requester with a natural language processor;
determine, based on analyzing a risk level of the request, a minimum number of approval points required to approve the request;
communicate, based on analyzing the request, with an information system external to the dynamic approval system;
analyze a first approver, based on communicating with the information system, including determining a first number of approval points allotted to the first approver;
add the first approver to an approval group, including adding the first number of approval points to a group number of approval points;
compare the group number of potential approval points to the minimum number of approval points; and
send a first approval request to the first approver in response to the group number of potential approval points having been greater than or equal to the minimum number of approval points.

9. The dynamic approval system of claim 8, wherein the memory comprises further instructions which, when executed by the computing processor, specifically configures the computing processor and causes the computing processor to:
determine that a first time limit has been reached;
remove the first approver from the approval group;
analyze a second approver;
add the second approver to the approval group; and
send the second approver a second approval request.

10. The dynamic approval system of claim 9, wherein the memory comprises further instructions which, when executed by the computing processor, specifically configures the computing processor and causes the computing processor to:
determine that a second time limit has been reached; and
deny the request.

11. The dynamic approval system of claim 8, wherein the memory comprises further instructions which, when executed by the computing processor, specifically configures the computing processor and causes the computing processor to:
analyze a third approver, including determining a third number of approval points allotted to the first approver, in response to the group number of potential approval points being less than the minimum number of approval points;
add the third approver to an approval group, including adding the third number of approval points to the group number of potential approval points;
compare again the group number of approval points to the minimum number of approval points; and
send the first approval request to the first approver and a third approval request to the third approver in response to the group number of potential approval points being greater than or equal to the minimum number of approval points.

12. The dynamic approval system of claim 8, wherein the memory comprises further instructions which, when executed by the computing processor, specifically configures the computing processor and causes the computing processor to:
receive a first approval from the first approver;
add the first number of approval points to a group number of received approval points;
compare the group number of received approval points to the minimum number of approval points; and
notify the requester of approval of the request in response to the group number of received approval points being greater than or equal to the minimum number of approval points.

13. The dynamic approval system of claim 8, wherein analyzing the first approver further comprises:
determine, based on communicating with the information system, a first effectiveness of the first approver with respect to the request.

13. The dynamic approval system of claim 13, wherein the first effectiveness is based on a request load, an availability, request subject matter knowledge, an absolute position in an organization of the first approver, and a relative position in the organization with respect to the requester.

15. A computer program product comprising a computer readable storage medium having a computer readable program stored therein to process natural language text, wherein the computer readable program, when executed on a computing device, specifically configures the computing device, and causes the computing device to:
analyze a request from a requester with a natural language processor;
determine, based on analyzing a risk level of the request, a minimum number of approval points required to approve the request;
communicate, based on analyzing the request, with an information system external to the dynamic approval system;
analyze a first approver, based on communicating with the information system, including determining a first number of approval points allotted to the first approver;
add the first approver to an approval group, including adding the first number of approval points to a group number of approval points;
compare the group number of potential approval points to the minimum number of approval points; and
send a first approval request to the first approver in response to the group number of potential approval points having been greater than or equal to the minimum number of approval points.

16. The computer program product of claim 15, wherein the computer readable program, when executed on a computing device, specifically further configures the computing device, and further causes the computing device to:
determine that a first time limit has been reached;
remove the first approver from the approval group;
analyze a second approver;
add the second approver to the approval group; and
send the second approver a second approval request.

17. The computer program product of claim 16, wherein the computer readable program, when executed on a computing device, specifically further configures the computing device, and further causes the computing device to:
determine that a second time limit has been reached; and
deny the request.

18. The computer program product of claim 15, wherein the computer readable program, when executed on a computing device, specifically further configures the computing device, and further causes the computing device to:
analyze a third approver, including determining a third number of approval points allotted to the first approver, in response to the group number of potential approval points being less than the minimum number of approval points;
add the third approver to an approval group, including adding the third number of approval points to the group number of potential approval points;
compare again the group number of approval points to the minimum number of approval points; and
send the first approval request to the first approver and a third approval request to the third approver in response to the group number of potential approval points being greater than or equal to the minimum number of approval points.

19. The computer program product of claim 15, wherein the computer readable program, when executed on a computing device, specifically further configures the computing device, and further causes the computing device to:
receive a first approval from the first approver;
add the first number of approval points to a group number of received approval points;
compare the group number of received approval points to the minimum number of approval points; and
notify the requester of approval of the request in response to the group number of received approval points being greater than or equal to the minimum number of approval points.

20. The computer program product of claim 15, wherein analyzing the first approver further comprises:
determine, based on communicating with the information system, a first effectiveness of the first approver with respect to the request, wherein the first effectiveness is based on a request load, an availability, request subject matter knowledge, an absolute position in an organization of the first approver, and a relative position in the organization with respect to the requester.
